(19) United States
(12) Patent Application Publication
(10) Pub. No.: US 2011/0247510 A1
(43) Pub. Date: Oct. 13, 2011

(54) Device and Method for Preparing a Liquid Mixture

(75) Inventor: Clemens Johannes Maria De Vroome, Beugen (NL)

(73) Assignee: GOSS CONTIWEB B.V., Boxmeer (NL)

(21) Appl. No.: 13/063,387

(22) PCT Filed: Sep. 10, 2009
(86) PCT No.: PCT/EP09/61775

§ 371 Date: Jun. 27, 2011

(30) Foreign Application Priority Data
Sep. 10, 2008 (EP) 08305542.6

(51) Int. Cl. B41F 31/03; C09D 7/12; B01F 15/02; B01F 9/00; B01F 17/54; B01F 3/08

(52) U.S. Cl. 101/327; 366/176.3; 366/152.6; 366/348; 366/343; 106/287.1

(57) ABSTRACT

A device for preparing a liquid mixture that is to be applied to a printing material is provided. The device includes a first reservoir containing a first ingredient of the liquid mixture, a supply source for a second ingredient of the liquid mixture, a mixing tank for receiving the at least first and second ingredients and for mixing the ingredients to obtain the liquid mixture, and supply lines to convey the first ingredient and the second ingredient from the first reservoir and the supply source to the mixing tank. The first ingredient includes less than 60, preferably less than 50, and most preferably less than 25 weight % of water, and in particular is an essentially waterless ingredient. A method is also provided.

The present invention pertains to a device for preparing a liquid mixture that is to be applied to a printing material and to a method for preparing a liquid mixture that is to be applied to a printing material.

### BACKGROUND

In rotary offset printing presses, a paper web is typically unrolled off a supply roll and guided through a plurality of printing units which print the web in multiple colors on both sides using the wet offset method. For drying the web and the wet printing ink, the web is guided through a hot air dryer in which water and volatile solvents of the printing ink vaporize. For setting the liquid ink, the web is subsequently guided over chill rolls of a chill roll stand, the chill rolls being flushed by a cooling medium. Finally, for producing the finished printing products, the web is fed to a folding machine which may fold and cut the web in different configurations.

In order to prevent a build-up of printing ink on guide elements for the web, a silicone oil emulsion may be applied to the dried web in known devices. At the same time, the water content of the emulsion makes desired rewetting of the web after drying possible.

A device for preparing a liquid mixture that is to be applied to a printing material is known from document US 2004/0173149 A1. This device is used to prepare an emulsion of silicone oil in water. The emulsion is prepared with two ingredients that are fed into a mixing tank, the first ingredient being a silicone oil concentrate, and the second ingredient being tap water. The silicone oil concentrate is stored in a reservoir. This reservoir is sufficiently large so that an exchange of the reservoir is only very seldom necessary. Accordingly, the silicone oil concentrate stays in the reservoir over a long period of time, which can be in the order of several months.

The storage of the concentrate over such time periods is however in conflict with the limited stability of the concentrate. Indeed, the concentrate is a concentrated emulsion of silicone oil in water, and, when such an emulsion is kept in storage, with time, the silicone oil separates out, leading to an upper oil layer and a lower water layer. In other words, the concentrate decays with time.

In the context of the device known from US 2004/0173149 A1, this means that, after a certain amount of time, one can no longer be sure that the first ingredient provided by the reservoir still corresponds to the concentrate that is needed to mix the liquid mixture. With this known device, one therefore has to regularly check the concentrate in the reservoir, and if necessary, renew it. Otherwise, there is the risk that the prepared liquid mixture does not have the desired composition and properties.

Also, the containers with the concentrate cause expenses with respect to logistics as they need to be ordered, transported and stored.

Furthermore, in order to stabilize the concentrate, additives, such as biocides, rust inhibitors and antistatic components are added to the concentrate. These additives are expensive and may modify the remoistening properties of the concentrate.

### SUMMARY OF THE INVENTION

An object of the present invention includes a device and a corresponding method that ensure a reliable and economic liquid mixture supply over a long period of time for a device that applies the liquid mixture to a printing material.

The present invention provides a device and method, the device comprising:

a first reservoir containing a first ingredient of the liquid mixture, a supply source for a second ingredient of the liquid mixture, a mixing tank for receiving the at least first and second ingredients and for mixing the ingredients to obtain the liquid mixture, and means to convey the first ingredient and the second ingredient from the first reservoir and the supply source to the mixing tank;

and to a method for preparing a liquid mixture that is to be applied to a printing material, the method comprising the following steps: providing a first ingredient of the liquid mixture, providing a second ingredient of the liquid mixture, mixing at least the first and second ingredient to obtain the liquid mixture;

both being characterized in that the first ingredient comprises less than 60, preferably less than 50, and most preferably less than 25 weight % of water, in particular is an essentially waterless ingredient.

In the context of the invention, an “essentially waterless” ingredient is an ingredient which only contains trace amounts of water. In other words, an essentially waterless ingredient is an ingredient which contains virtually no water.

Another object of the invention is to store ingredients with a reduced or minimized water content compared to the concentrate stored so far. These ingredients remain stable over a longer period of time. This allows the use of larger reservoirs, which saves costs. Furthermore, the higher stability leads to a more accurate mixing of the liquid mixture.

According to preferred embodiments, the device of the invention may include one or several of the following features, taken in isolation or in all technically possible combinations:

the first ingredient is a mixture, preferably a mixture of silicone oil and an emulsifier which constitute at least 80, preferably at least 90, and most preferably at least 99 weight % of the mixture, the first ingredient being in particular a paste-like emulsion made of pure silicone oil and an emulsifier;

the first ingredient is silicone oil;

the second ingredient is water;

a rotatable mixer is located inside the mixing tank, the rotatable mixer being adapted to mix the ingredients to obtain the liquid mixture, the mixer preferably being a high shear mixer;

the conveying means comprise a piston fitted inside the first reservoir, the piston being adapted to push the first ingredient out of the first reservoir;

a piston rod connected to the piston and a bore in the piston and/or the piston rod, the bore being adapted to act as an outlet for the first ingredient out of the first reservoir;

a first buffer container used for the first ingredient, this first buffer container being arranged between the first reservoir and the mixing tank; and

means to convey the first ingredient from the first reservoir to the first buffer container, and then from the first buffer container to the mixing tank;

a movable member fitted inside the first buffer container, the movable member being adapted to push the first ingredient out of the first buffer container towards the mixing tank;

control means adapted to move the movable member so as to push out the first ingredient in reply to a detection of a low filling status of the first reservoir;

a second reservoir containing a third ingredient, preferably an emulsifier, of the liquid mixture; and

means to convey the third ingredient from the second reservoir to the mixing tank, these means preferably comprising a second buffer container for the third ingredient;

a third reservoir containing a fourth ingredient of the liquid mixture; and means to convey the fourth ingredient from the third reservoir to the mixing tank, these means preferably comprising a third buffer container for the fourth ingredient;

the fourth ingredient is a silicone oil substitute, preferably wax powder;

means for applying the liquid mixture to the printing material, and means to convey the liquid mixture from the mixing tank to the means for applying the liquid mixture;

the liquid mixture is an emulsion, preferably an emulsion of silicone oil in water.

Similarly, the method of the invention may include one or several of the following features:

the first ingredient is a mixture, preferably a mixture of silicone oil and an emulsifier which constitute at least 80, preferably at least 90, and most preferably at least 99 weight % of the mixture, the first ingredient being in particular a paste-like emulsion made of pure silicone oil and an emulsifier;

the first ingredient is silicone oil;

the second ingredient is water;

the mixing is done using a rotatable mixer, preferably a high shear mixer;

the steps of: providing a third ingredient, preferably an emulsifier, of the liquid mixture; and mixing the third ingredient together with the first and second ingredient to obtain the liquid mixture;

the steps of providing a fourth ingredient of the liquid mixture; and mixing the fourth ingredient together with the other ingredients to obtain the liquid mixture;

the fourth ingredient is a silicone oil substitute, preferably wax powder;

the liquid mixture is an emulsion, preferably an emulsion of silicone oil in water.

The invention also provides a chill roll stand and/or a printing press comprising a device according to the invention.

### BRIEF DESCRIPTION OF THE DRAWINGS

The invention will be better understood when reading the following description of non-limiting examples of the invention, with reference to the accompanying drawings, in which:

FIG. 1 shows a first embodiment of a liquid mixture preparation device according to the present invention, the device being integrated into a chill roll stand; and

FIG. 2 shows a second embodiment of a liquid mixture preparation device according to the present invention.

### DETAILED DESCRIPTION OF PREFERRED EMBODIMENTS

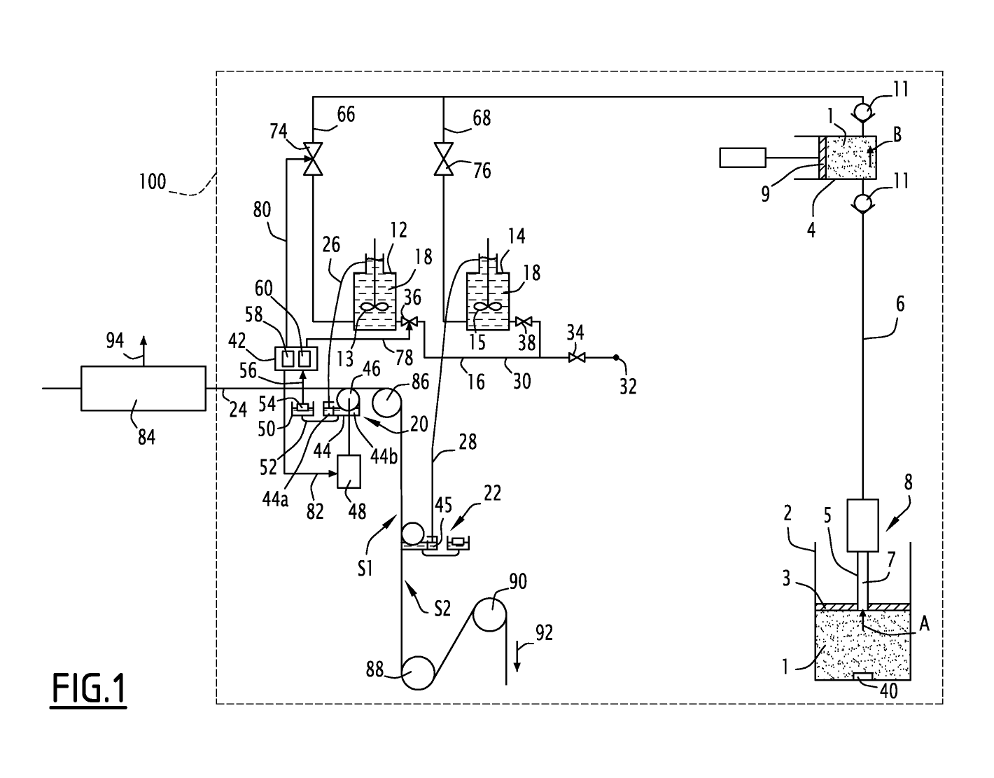

With reference to FIG. 1, a material web 24, in particular a printing material web 24, made of paper, for example, is, after being unrolled and imprinted in printing units, guided in moving direction 92 through a hot air dryer 84 and, for cooling, subsequently through a chill roll stand 100 over chill rolls 86, 88, and 90 which are flushed with a cooling medium. In FIG. 1, chill roll stand 100 is represented by a rectangle drawn with dashed lines.

Due to the hot air in dryer 84, which vaporizes solvents of the printing ink, moisture 94 is also removed from web 24 so that it may be necessary to subsequently rewet web 24, at least partially.

Cooling of web 24 results in setting of the printing ink. However, a printing ink build-up on guide rolls or guide surfaces in subsequent press components, in the folding machine, for example, may occur nevertheless. This ink build-up may be countered by applying silicone oil on web 24.

A first ingredient 1 is accommodated in a reservoir 2. According to the first embodiment, this first ingredient 1 is a paste-like emulsion made of pure silicone oil and an emulsifier, which, in the following, will simply be referred to as silicone paste 1. Silicone paste 1 has the particularity that it does not contain any water, or only trace amounts of water. This means that the silicone oil and the emulsifier constitute at least 99 weight percent of the paste. This makes silicone paste 1 particularly stable so that it can be safely stored over a long time period (e.g. several months) without an appreciable change of composition or properties and with little or no additives as mentioned in the introduction. Alternatively, the silicone oil and the emulsifier may be a part of the paste, starting from at least 80 weight percent, e.g. 80, 85, 90, or 95 weight percent.

The reservoir 2 may accommodate a sufficient quantity of silicone paste 1 so that an exchange of reservoir 2 is only very seldom necessary, after several print jobs, for example. The reservoir 2 may be a barrel, for example. The barrel may have a volume of around 200 liters, for example.

Reservoir 2 is connected to a buffer container 4 for the silicone paste 1 via a supply line 6. Line 6 has a pump 8 which conveys silicone paste 1 from reservoir 2 to buffer container 4 in a desired quantity. Pump 8 includes a piston 3 and a piston rod 5. Piston rod 5, which is connected to piston 3, has a central bore 7. When pushing the piston 3 towards the bottom of reservoir 2, the silicone paste 1 is forced out of the reservoir 2 via the central bore 7 towards the buffer container 4, as indicated by arrow A.

A constant fill level is maintained in buffer container 4, e.g. about 5 liters of paste, as long as reservoir 2 contains sufficient silicone paste 1 which is being conveyed continuously, quasi-continuously, or intermittently by pump 8.

A sensor-controlled warning device 40 which monitors the fill level of reservoir 2 for reaching a lowest level may indicate an imminently necessary exchange of reservoir 2 to the operator, for example. At the moment of reaching the lowest fill level, it is also possible to automatically switch over to a second reservoir. During the reservoir exchange, the supply with silicone paste 1 is ensured by buffer container 4 so that a disruption of the silicone paste supply is prevented. To this end, buffer container 4 is fitted with a movable member, namely a piston 9, which, when pushed towards the bottom of buffer container 4, forces the silicone paste 1 out of buffer container 4, in the direction indicated by arrow B. Direction B is defined by two check valves 11.

Furthermore, the device according to the present invention has a mixing tank 12 and a mixing tank 14 in which silicone paste 1 is mixed with second ingredient 16, assumed in the following in an exemplary but not restrictive manner to be water 16, to form a liquid mixture 18, an emulsion of silicone oil in water in this case.

Water 16 is supplied from a supply source 32 to mixing tanks 12 and 14 via conveying means which comprise a supply line 30, a pressure control valve 34, and two further valves 36, 38. Supply source 32 may be implemented in the form of a common water connection. pressure control valve 34 initially modifies the pressure of water 16 of supply source 32, by reducing it, for example, and subsequently calibrated valves 36 and 38 control the water flow 16 to the two mixing tanks 12 and 14, respectively, by opening and closing. The combined use of a pressure control valve 34 and a calibrated valve 36 or 38 makes the water flow (quantity per time) controllable or regulatable, and thus adjustable.

The water pressure is kept constant by pressure control valve 34 so that a constant pressure is present at the inlet side of valves 36, 38. Valves 36 and 38 may be controlled electrically and may be designed as solenoid valves including an actuator coil so that they increase, reduce, or interrupt the water flow 16 proportionally to the electric control signal.

Silicone paste 1 is supplied to mixing tanks 12, 14 via supply lines 66, 68 which each have an electrically controllable valve 74, 76, solenoid valves including an actuator coil, for example. Controlled opening of a valve 74 or 76 allows for a certain quantity or a certain flow of silicone paste 1 to flow into mixing tanks 12 or 14. In the paste supply lines 66, 68, a constant pressure is maintained, so that when a valve 74, 76 opens, a known amount of silicone paste 1 goes through.

As shown in the embodiment of FIG. 1, the flow of silicone paste 1 may take place solely due to gravity which means, for example, that the use of an extra pump may be dispensed with if buffer tank 4 is situated higher than mixing tanks 12, 14. The selected, constant height of fall and the degree of opening of valves 74, 76 determine the flow in supply lines 66, 68. Thus, a constant pressure is present at the inlet side of valves 74, 76.

In summary, pump 8, supply line 6, check valves 11, buffer tank 4, supply lines 66, 68, and valves 74, 76, may commonly be designated as means to convey the first ingredient, i.e. silicone paste 1, from reservoir 2 to mixing tanks 12, 14 and be for example, a first ingredient supply source.

Valves 36, 38 as well as valves 74, 76 may be periodically controlled with a selectable period and length of opening time so that the flow is accurately adjustable.

Mixing tank 12 supplies an applicator 20, which applies liquid mixture 18 to a first side S1 of web 24, via a conveying means or supply line 26. Mixing tank 14 supplies an applicator 22, which applies liquid mixture 18 to a second side S2 of web 24, via a conveying means or supply line 28. The mixing tanks 12, 14 have a small volume so that concentration variations, caused by opening and closing of valves 36, 38, 74, 76, are quickly attenuated.

High shear mixers 13, 15 are utilized to stir the water 16 with the silicone paste 1 in order to obtain the silicone emulsion 18. High shear mixer 13 is located inside mixing tank 12, and high shear mixer 15 inside mixing tank 14. The result of the mixing is a silicone emulsion 18 made of only silicone oil, water and emulsifier with a lifetime of one to two weeks. This lifetime is sufficient since the prepared emulsion 18 is consumed within a few days. Mixing tanks 12, 14 each have an overflow, which allows the prepared silicone emulsion 18 to flow into troughs 44, 45 via supply lines 26, 28

The cooperation of the known, constant height of fall of the paste and the known control of valves 74, 76 with regard to period and length of opening time makes the control or regulation of the paste quantity supplied possible in a simple way. For example, pumps are thus not necessary, and neither is a measuring device for measuring the flow through.

As an example, only the application of silicone emulsion 18 on the first side S1, i.e. the bottom side, of web 24 is described in the following, it being assumed that the same is also true for the second side S2 of web 24, in particular that elements not shown are also assumed to exist with regard to the application to the second, opposite top side S2.

Applicator 20 includes a container 44, a trough 44, for example, which receives liquid mixture 18, and from which an applicator roll 46 scoops liquid mixture 18 and applies the liquid mixture to the appropriate side of web 24. For this purpose, applicator roll 46 is driven by a motor 48 which determines the rotational speed of applicator roll 46 and thus the quantity of liquid mixture 18 transferred and applied to web 24. More liquid mixture 18 is transferred at higher rotational speed, versus less liquid mixture at lower rotational speed.

Trough 44 has two sections 44a and 44b, liquid mixture 18 being fed into section 44a from where liquid mixture 18 flows evenly over a partition between the two sections and arrives in section 44b. Applicator roll 46 submerges into section 44b and takes up liquid mixture 18. It may be ensured in this way that roll 46, across its axial extension, takes up and transfers liquid mixture 18 evenly, since section 44b is always filled evenly in its axial extension, while section 44a is being filled via supply line 26 at one or several points.

A regulating and/or control unit 42, for the sake of simplicity referred to below as controller 42, monitors the fill level of liquid mixture 18 in trough 44 of applicator 20. Trough 44 is connected to a measuring vessel 50 via a communicating line 52, a float element 54 being situated in vessel 50 which, continuously or in intervals, for example, transmits the instantaneous fill level in trough 44 to controller 42 in the form of a signal and/or in the form of a data stream via a signal line and/or data line 56.

Controller 42 includes a memory unit 58 in which the following data is stored:

silicone oil concentration K of the silicone paste 1 in reservoir 2; instantaneous web speed V (10.5 m/s for example) of web 24;

web width W (1905 mm for example) of web 24 currently being processed;

the setpoint value for water application WA1 (1900 mg/m² for example) onto the first side S1 of web 24;

the setpoint value for water application WA2 (1900 mg/m² for example) onto the second side S2 of web 24;

the setpoint value for silicone oil application SA1 (25 mg/m² for example) onto the first side S1 of web 24;

the setpoint value for silicone oil application SA2 (60 mg/m² for example) onto the second side S2 of web 24.

Values WA1, WA2, SA1, and SA2 may have been determined empirically; for certain print jobs (e.g., parameters for printing material, printing inks, wetting agent, surface coverage, dry treatment, web temperature), the best values for WA1, WA2, SA1, and SA2 having been determined manually and, for subsequent presetting, having been stored in memory unit 58 together with the print job number. However, it is also possible that, in a certain print job (e.g., parameters for printing material, printing inks, wetting means, surface coverage, dry treatment, web temperature), a processor 60 of controller 42 determines the best possible values for WA1, WA2, SA1, and SA2, using an algorithm, and stores them in memory unit 58.

From the values of WA1, WA2, SA1, and SA2, processor 60, knowing the values for K, V, and W, and based on an algorithm or a lookup table, may determine with which rotational speed applicator roll 46 must be driven and/or what quantity or what flow rate of silicone oil paste 1 and water 16 must continuously, quasi-continuously, or intermittently be fed to the mixing tank by controlling valves 36, 38, and 74, 76. In the event that the flow through valves 36, 38, 74, and 76 in their fully opened state is also stored in memory unit 58, the algorithm is able to determine the necessary opening times or opening intervals of the valves.

In the event that the flow through valves 36, 38, 74, and 76 at their given degree of opening is stored in memory unit 58, the algorithm is able to determine the necessary degree of opening of the valves for certain time intervals.

Valves 36, 38, 74, and 76 are generally calibrated so that the flow through the valves is known and may be obtained from a valve data sheet, for example.

Valves 74, 76 are preferably operated intermittently, i.e., fully opened and closed again in sequence, for example; the frequency and/or the opening time may be variable. Valves 36, 38 are preferably operated continuously or quasi-continuously with a variable degree of opening.

For opening and closing of valves 36 and 74, controller 42 is connected to the same via signal lines or data lines 78 and 80, respectively. Controller 42 controls motor 48 via a signal and/or data line 82.

The values of SA1 and SA2 in the aforementioned example are evidently different, which may occur, for example, when both sides of web 24 have different surface ink coverage, or when one side of web 24 comes into contact with more guide rolls or guide surfaces, a fold guide for example, than the other side. It may be reasonable in both cases to apply more silicone oil to the appropriate side of web 24, but to keep the water quantity constant for both sides. In such a case, the device according to the present invention allows in an advantageous manner to separately control or regulate the proportion of silicone oil, as well as the proportion of water of the mixed emulsion 18 for both sides. Here, for example, silicone oil paste 1 is only buffered in a small quantity, but which is sufficient for an exchange of reservoir 2.

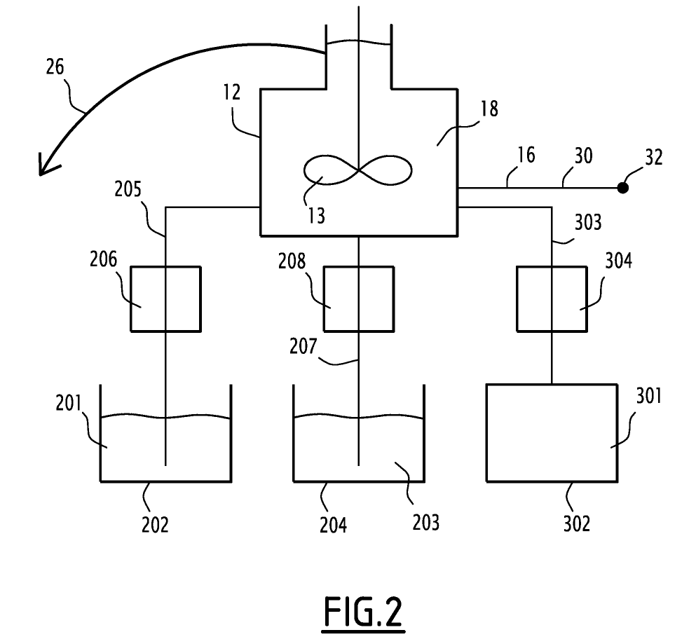

FIG. 2 exemplifies a second embodiment of a device of the present invention. This second embodiment is in most parts identical to the first embodiment. FIG. 2 mainly shows those parts of the device, which are different compared to FIG. 1, identical parts having mostly been omitted.

The second embodiment is characterized by the presence of two reservoirs 202 and 204 containing two ingredients 201, 203 for the liquid mixture 18, instead of the single reservoir 2 of FIG. 1. Reservoir 202 contains pure silicone oil 201, and reservoir 204 contains an emulsifier 203, both the silicone oil 201 and the emulsifier 203 being essentially waterless. Silicone oil 201 is supplied to mixing tank 12 via a supply line 205 and a buffer tank 206. Similarly, emulsifier 203 is supplied to mixing tank 12 via a supply line 207 and a buffer tank 208. In mixing tank 12, a high shear mixer 13 mixes silicone oil 201, emulsifier 203 and water 16 to obtain the desired silicone emulsion 18.

According to this second embodiment, the three components required for the mixing of the silicone emulsion 18, namely silicone oil, emulsifier and water, are each stored separately. They are simultaneously combined when the silicone emulsion 18 is actually needed for application to the paper web 24. Since the silicone oil 201 and the emulsifier 203 do not contain water, the silicone oil 201 and emulsifier 203 are more stable and can be stored longer than, for example, a pre-prepared concentrated emulsion of silicone oil in water, as suggested in US 2004/0173149 A1.

Optionally, the device according to FIG. 1 or FIG. 2 may additionally comprise a reservoir 302 with a further ingredient, namely waterless wax powder 301. Wax powder 301 may be supplied to the mixing tank 12 via further supply line 303 and buffer tank 304, as a further ingredient to silicon emulsion 18. This wax powder 301 may be added to replace a certain amount of silicone oil 201 or silicone paste 1. Substitution of a part of the silicone oil by wax powder is a cost effective option, since wax powder tends to be cheaper than pure silicone oil.

In the above described embodiments, essentially waterless ingredients are stored and mixed with water to obtain the liquid mixture. Nevertheless, it is also possible to use ingredients with a reduced water content compared to the concentrate used in US 2004/0173149 A1. Such ingredients may comprise between zero and sixty weight percent of water, e.g. less than 5, 10, 15, 20, 25, 30, 35, 40, 45, 50, 55, or 60 weight percent of water.

It is a particular advantage of the present invention that, due to the device or method, the proportion or allotment of water and the proportion or allotment of silicone oil and emulsifier (FIG. 2) or silicone paste (FIG. 1) in the liquid mixture 18 may be adjusted separately from one another and targeted for each web side according to the print job parameters. The web may thus be accurately wetted and also provided with sufficient silicone oil.

Furthermore, the device according to the present invention makes it possible to modify the percentage composition of liquid mixture 18 according to printing requirements within a short response time since the mixing tanks-due to the continuous, quasi-continuous, or intermittent inflow of water and silicone oil plus emulsifier or silicone paste-may be designed to have a very small volume or volumetric capacity, approximately one liter for example, compared to that of the buffering container(s), approximately five liters, for example.

Both mixing tanks 12, 14 are essentially always filled during operation, for example, because controller 42 controls or regulates an essentially continuous replenishment of mixing tanks 12, 14 and troughs 44, 45 as a function of the signal of float element 54.

Since the proportion of water in liquid mixture 18 constitutes the largest part, in most cases more than approximately 95%, for example, float element 54, in the event of a drop of the level, may operate or trigger the opening of valve 36 directly, so that controller 42 only ensures the appropriate flow of silicone oil and emulsifier or silicone paste, in order to produce the desired mixture.

The liquid mixture may flow to troughs 44, 45 by gravity or via pumps.

Although not shown in the figures, those skilled in the art will recognize that the device according to the present invention may also have at least one temperature control device (or one for each side of the web) for liquid mixture 18. Conventional heat exchangers or heating devices lend themselves for this purpose.

Due to the essentially continuous and controlled and/or regulated flow of liquid mixture 18 to both troughs 44, 45, feedbacks from troughs 44, 45 to mixing tanks 12, 14 may be advantageously dispensed with in the design according to the present invention, the device thus having a less complex construction. Also the flow of silicone paste 1 from reservoir 2 to buffer tank 4, respectively the flow of silicone oil 201 and emulsifier 203 from reservoirs 202, 204 to buffer tanks 206, 208, may be essentially continuously (quasi-continuously) controlled and/or regulated by controller 42.

According to the present invention, controller 42 is part of the chill roll stand 100. However, it may also be part of the press control and may, for example, be integrated into the central control system of the printing press. Alternatively, controller 42 may be part of a dryer 84 integrating chill roll stand 100. In this way, a separate controller 42 associated with the chill roll stand 100—i.e., a separate computer or a processor including a memory-may be dispensed with, thereby saving costs.

Furthermore, the operator may have the option to manually adapt the set point values for WA1, WA2, SA1, and SA2 of the current print job so that these improved values may be stored in memory unit 58 for presetting for future print jobs.

What is claimed is:

1-24. (canceled)

25. A device for preparing a liquid mixture that is to be applied to a printing material, the device comprising:
a first supply source including a first reservoir containing a first ingredient of the liquid mixture;
a second supply source for a second ingredient of the liquid mixture;
a mixing tank for receiving the first and second ingredients and for mixing the first and second ingredients to obtain the liquid mixture; and
supply lines to convey the first ingredient and the second ingredient from the first reservoir and the second supply source to the mixing tank,
the first ingredient being less than 60 weight % of water.

26. The device of claim 25, wherein the first ingredient is a mixture that includes silicone oil and an emulsifier, the silicone oil and emulsifier being at least 80 weight % of the mixture.

27. The device of claim 25, wherein the first ingredient is silicone oil.

28. The device of claim 25, wherein the second ingredient is water.

29. The device of claim 25, further comprising a rotatable mixer located inside the mixing tank, the rotatable mixer for mixing the first and second ingredients to obtain the liquid mixture.

30. The device of claim 25, wherein the first supply source includes a piston fitted inside the first reservoir, the piston being adapted to push the first ingredient out of the first reservoir.

31. The device of claim 30, further comprising a piston rod connected to the piston and a bore in the piston or the piston rod, the bore acting as an outlet for the first ingredient out of the first reservoir.

32. The device of claim 25, further comprising:
a first buffer container for the first ingredient, the first buffer container being arranged between the first reservoir and the mixing tank; and
the supply lines conveying the first ingredient from the first reservoir to the first buffer container, and then from the first buffer container to the mixing tank.

33. The device of claim 32, further comprising a movable member fitted inside the first buffer container, the movable member pushing the first ingredient out of the first buffer container towards the mixing tank.

34. The device of claim 33, further comprising a controlling device adapted to move the movable member so as to push out the first ingredient in reply to a detection of a low filling status of the first reservoir.

35. The device of claim 25, further comprising:
a second reservoir including a third ingredient of the liquid mixture; and
a supply line to convey the third ingredient from the second reservoir to the mixing tank.

36. The device of claim 35, further comprising:
a third reservoir containing a fourth ingredient of the liquid mixture; and
a supply line to convey the fourth ingredient from the third reservoir to the mixing tank.

37. The device of claim 36, wherein the fourth ingredient is a silicone oil substitute.

38. The device of claim 25, further comprising applicators for applying the liquid mixture to the printing material, and supply lines for conveying the liquid mixture from the mixing tank to the applicators.

39. A chill roll stand comprising a device according to claim 25.

40. A method for preparing a liquid mixture to be applied to a printing material, the method comprising the steps of:
providing a first ingredient of the liquid mixture the first ingredient being less than 60 weight % of water;
providing a second ingredient of the liquid mixture; and
mixing at least the first and second ingredient to obtain the liquid mixture.

41. The method of claim 40, wherein the first ingredient is a mixture that includes silicone oil and an emulsifier, the silicone oil and emulsifier being at least 80 weight % of the mixture.

42. The method of claim 40, wherein the first ingredient is silicone oil.

43. The method of claim 40, wherein the second ingredient is water.

44. The method of claim 40, wherein the mixing is done using a rotatable mixer.

45. The method of claim 40, further comprising the steps of:
providing a third ingredient to the liquid mixture; and
mixing the third ingredient together with the first and second ingredients to obtain the liquid mixture.

46. The method of claim 40, further comprising the steps of:
providing a fourth ingredient to the liquid mixture; and
mixing the fourth ingredient together with the first, second and third ingredients to obtain the liquid mixture.

47. The method of claim 46, wherein the fourth ingredient is a silicone oil substitute.

48. The device of claim 25, wherein the liquid mixture is an emulsion of silicone oil in water.

49. The device of claim 25, wherein the first ingredient is a waterless ingredient.

50. The device of claim 35, wherein the third ingredient is an emulsifier.

51. A printing press comprising a device according to claim 25.
